(19) United States
(12) Patent Application Publication
(10) Pub. No.: US 2009/0073608 A1
(43) Pub. Date: Mar. 19, 2009

(54) Perpendicular magnetic recording head

(76) Inventors: Norihiro Ookawa, Kanagawa (JP); Atsushi Kato, Kanagawa (JP); Makoto Morijiri, Kanagawa (JP); Tomohiro Okada, Kanagawa (JP); Wataru Kimura, Kanagawa (JP)

Correspondence Address: TOWNSEND AND TOWNSEND AND CREW LLP, TWO EMBARCADERO CENTER, 8TH FLOOR, SAN FRANCISCO, CA, 94111, US

(21) Appl. No.: 12/229,561

(22) Filed: Aug. 22, 2008

(30) Foreign Application Priority Data
Aug. 24, 2007 (JP) 2007-218566

(51) Int. Cl. G11B 5/127

(52) U.S. Cl. 360/125.03

(57) ABSTRACT

Embodiments of the present invention provide a perpendicular magnetic recording head suitable for high density recording that suppresses erasure after recording by reducing the remanent magnetization Mr of the main magnetic pole and thereby decreasing the squareness S. Accordingly to one embodiment, a main magnetic pole piece of a perpendicular magnetic recording head includes a FeCo ferromagnetic layer, into which a NiFe soft magnetic layer is inserted. Inserting the NiFe soft magnetic layer in a position in the FeCo ferromagnetic layer 1 to 7 mm away from a nonmagnetic layer allows a remanent magnetization Mr to be decreased without changing the number of layers of the nonmagnetic layer or a film thickness of the FeCo ferromagnetic layer. This helps suppress erasure after recording.

### CROSS-REFERENCE TO RELATED APPLICATION

The instant nonprovisional patent application claims priority to Japanese Patent Application No. 2007-218566 filed Aug. 24, 2007 and which is incorporated by reference in its entirety herein for all purposes.

### BACKGROUND OF THE INVENTION

Magnetic disk drives (HDDs) allow an increase in information recording capacity, conversion speed, and reduction in error rates. Recent trends are toward greater magnetic recording densities. To meet these needs, research is underway into a scheme of recording, in which a magnetization direction of a recording film is perpendicular relative to a medium surface, which is what is called perpendicular recording, as compared with the longitudinal recording media that have conventionally been used. Practical application of perpendicular recording has already been started. In perpendicular recording, the higher the linear recording density, the less the demagnetizing field of the medium for more stabilized magnetization, which makes perpendicular recording suitable for higher recording densities. Known in perpendicular recording is, however, the problem of “erasure after recording”. This is a phenomenon, in which a recording head after a recording operation deteriorates recording signals on the medium. This is probably because remanent magnetization left in a main magnetic pole disturbs information recorded on the medium. Japanese Patent Publication No. 2004-199816 (“Patent Document 1”) proposes a use of a film stack of antiferromagnetically stacked ferromagnetic layers as the main magnetic pole in order to suppress erasure after recording.

FIG. 8 is a view showing schematically the main magnetic pole piece structure disclosed in Patent Document 1. The ma in magnetic pole piece includes an underlayer 50, on which stacked is a multilayered film having a soft magnetic film stack repeatedly stacked one on top of another via a non-coupled layer 56. The soft magnetic film stack includes a first ferromagnetic layer 52, an antiparallel coupled layer 54, and a second ferromagnetic layer 52. The two adjacent ferromagnetic layers 52 across the antiparallel coupled layer 54 are antiferromagnetically coupled such that the first ferromagnetic layer magnetization is antiparallel to the second ferromagnetic layer magnetization.

To suppress erasure after recording, a known approach is to use, as the main magnetic pole, a film stack of a FeCo ferromagnetic layer and a nonmagnetic layer and the ferromagnetic layer is antiferromagnetically coupled to reduce remanent magnetization Mr of the main magnetic pole, thus decreasing squareness S.

If the number of nonmagnetic layers is increased to reduce the remanent magnetization Mr and thereby decrease the squareness S, however, a saturation magnetic field Hs increases, leading to a reduced current response characteristic of the head. If on the other hand, a film thickness of the FeCo ferromagnetic layer is decreased to reduce the remanent magnetization Mr and thereby decrease the squareness S, there is a shortage of a recording magnetic field, leading to a degraded overwrite characteristic. It is therefore important to reduce the remanent magnetization Mr of the main magnetic pole and thereby decrease the squareness S without changing the number of nonmagnetic layers or the film thickness of the FeCo ferromagnetic layer.

### BRIEF SUMMARY OF THE INVENTION

Embodiments of the present invention provide a perpendicular magnetic recording head suitable for high density recording that suppresses erasure after recording by reducing the remanent magnetization Mr of the main magnetic pole and thereby decreasing the squareness S. According to the embodiment of FIG. 1, a main magnetic pole piece 2 of a perpendicular magnetic recording head I includes a FeCo ferromagnetic layer 22, into which a NiFe soft magnetic layer 24 is inserted. Inserting the NiFe soft magnetic layer 24 in a position in the FeCo ferromagnetic layer 22 1 to 7 nm away from a nonmagnetic layer 26 allows a remanent magnetization Mr to be decreased without changing the number of layers of the nonmagnetic layer 26 or a film thickness of the FeCo ferromagnetic layer 22. This helps suppress erasure after recording.

### BRIEF DESCRIPTION OF THE DRAWINGS

FIG. 1 is a view showing a main magnetic pole piece of a perpendicular magnetic recording head according to an embodiment of the present invention as viewed from a side of an air bearing surface.

FIG. 2 is a view showing composition and film thicknesses of the main magnetic pole piece shown in FIG. 1.

FIG. 3 are diagrams showing values of a squareness S when a film thickness of a FeCo layer adjacent the nonmagnetic layer is varied in the main magnetic pole piece shown in FIG. 1.

FIG. 4 is a diagram showing a magnetization curve of the main magnetic pole piece shown in FIG. 1.

FIG. 5 is a view for illustrating a decrease in the squareness S achieved by thinning the FeCo layer adjacent the nonmagnetic layer of the main magnetic pole piece shown in FIG. 1.

FIG. 6 is a cross-sectional view showing a general structure of the perpendicular magnetic recording head according to an embodiment of the present invention.

FIG. 7 is a perspective view showing the perpendicular magnetic recording head according to an embodiment of the present invention as viewed from the side of the air bearing surface.

FIG. 8 is a view showing schematically a main magnetic pole piece of a known art perpendicular magnetic recording head.

### DETAILED DESCRIPTION OF THE INVENTION

Embodiments of the present invention relate generally to a perpendicular magnetic recording head and, more particularly, to a structure of a main magnetic pole.

It is an object of embodiments of the present invention to provide a perpendicular magnetic recording head suitable for high density recording that suppresses erasure after recording by reducing the remanent magnetization Mr of the main magnetic pole and thereby decreasing the squareness S.

To achieve the foregoing object, a perpendicular magnetic recording head according to an aspect of embodiments of the present invention includes a write head. The write head has a main magnetic pole piece, an auxiliary magnetic pole piece, and a coil. Specifically, the auxiliary magnetic pole piece is magnetically coupled to the main magnetic pole piece on a side opposite an air bearing surface. The coil generates a magnetic flux in the main magnetic pole piece and the auxiliary magnetic pole piece. Further, the main magnetic pole piece includes a multilayered film. The multilayered film includes a nonmagnetic layer, FeCo ferromagnetic layers, and NiFe soft magnetic layers. The nonmagnetic layer includes one or a plurality of elements selected from the group consisting of Cr, Ru, Rh, and Ir. The FeCo ferromagnetic layers are disposed above and below the nonmagnetic layer. The NiFe soft magnetic layers are inserted in the FeCo ferromagnetic layers in the vicinity sides of the nonmagnetic layer with respect to a center in a layer thickness direction of each FeCo ferromagnetic layer.

The FeCo ferromagnetic layers disposed above and below the NiFe soft magnetic layers are ferromagnetically coupled and the FeCo ferromagnetic layers disposed above and below the nonmagnetic layer are antiferromagnetically coupled.

Preferably, the NiFe soft magnetic layer is inserted in the FeCo ferromagnetic layer 1 to 7 nm away from the nonmagnetic layer.

A plurality of multilayered films may preferably be stacked one on top of another via a NiCr intermediate nonmagnetic layer.

The perpendicular magnetic recording head further includes a read head that has an upper magnetic shield, a lower magnetic shield, and a magnetoresistive sensor disposed between the upper magnetic shield and the lower magnetic shield.

In accordance with an aspect of embodiments of the present invention, the remanent magnetization Mr of the main magnetic pole piece can be reduced to thereby decrease the squareness S without changing the number of layers of the nonmagnetic layers or the film thickness of the FeCo ferromagnetic layer. This allows erasure after recording to be suppressed and a perpendicular magnetic recording head suitable for high density recording to be obtained.

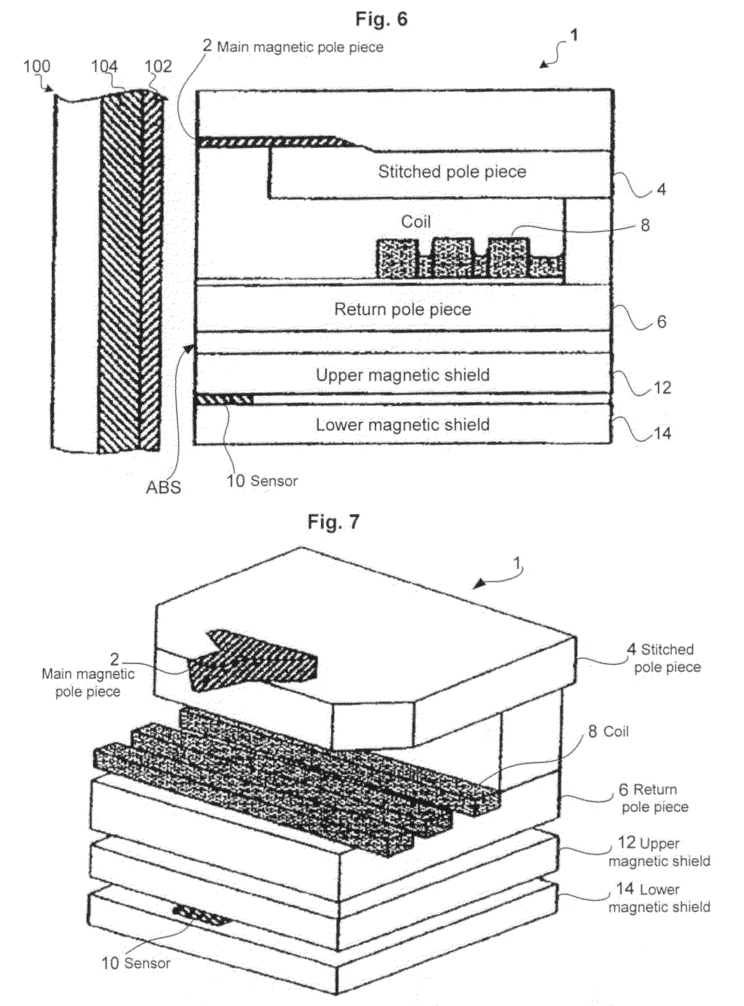

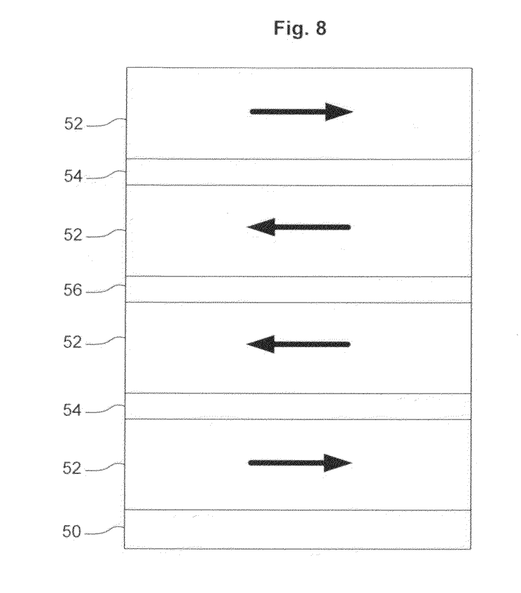

A general structure of a perpendicular magnetic recording head according to an embodiment of the present invention will be described with reference to FIGS. 6 and 7. FIG. 6 is a cross-sectional view showing the perpendicular magnetic recording head and FIG. 7 is a perspective view showing the perpendicular magnetic recording head as viewed from a side of an air bearing surface (ABS). A perpendicular magnetic recording head 1 has a write head and a read head. The write head includes a writing main magnetic pole piece (main magnetic pole piece) 2, a stitched pole piece (magnetic yoke portion) 4, a return pole piece (auxiliary pole piece) 6, and a coil 8. The magnetic yoke portion 4 is magnetically coupled to a rear portion of the main magnetic pole piece 2. The auxiliary pole piece 6 is magnetically coupled to the magnetic yoke portion 4 at a side opposite the ABS. The coil 8 is disposed so as to interlink with a magnetic circuit formed by the magnetic yoke portion 4 and the auxiliary pole piece 6. The read head is disposed adjacent the write head. The read head includes an upper magnetic shield 12, a lower magnetic shield 14, and a giant magnetoresistive (GMR) or tunneling magnetoresistive (TMR) sensor 10 disposed between the upper magnetic shield 12 and the lower magnetic shield 14. Current is passed through the coil 8 of the write head, so that a magnetic flux is generated in the magnetic circuit formed by the magnetic yoke portion 4 and the auxiliary pole piece 6. The magnetic flux is thereby induced in the main magnetic pole piece 2 and leaked toward a perpendicular magnetic recording medium 100. The magnetic flux from the main magnetic pole piece 2 passes through a soft magnetic backing layer 104 of the perpendicular magnetic recording medium 100 to return to the auxiliary pole piece 6, thus recording magnetization information in a perpendicular recording layer 102 immediately below the main magnetic pole piece 2.

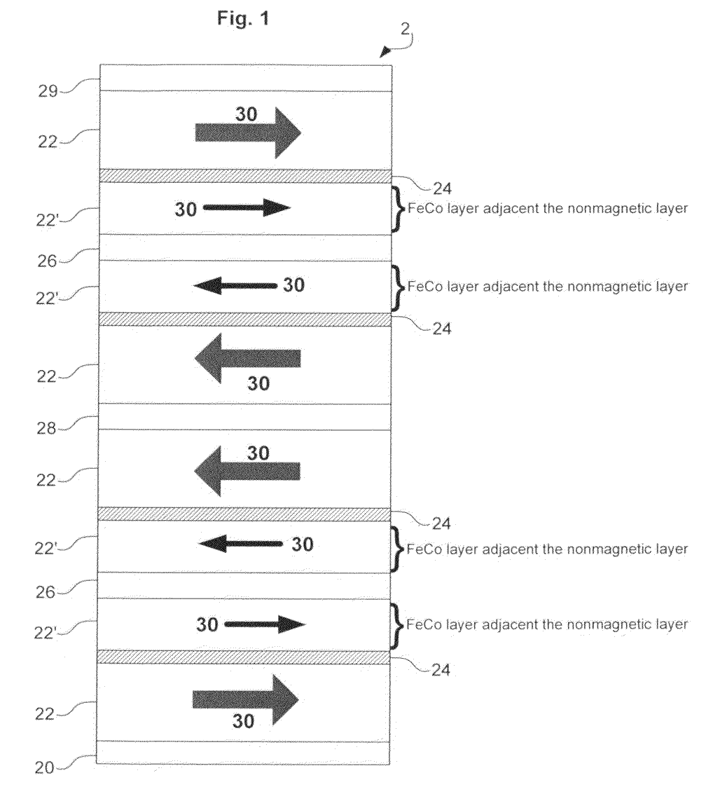

A layer structure of the main magnetic pole piece 2 of the perpendicular magnetic recording head I according to the embodiment of the present invention will be described below with reference to FIG. 1. FIG. 1 is a view showing the main magnetic pole piece 2 as viewed from the side of the ABS. A first ferromagnetic layer 22 formed of FeCo or other ferromagnetic material is formed on an underlayer 20 formed of a NiCr alloy or other nonmagnetic material. A first NiFe soft magnetic layer 24 is formed on the first FeCo ferromagnetic layer 22, on which a first FeCo ferromagnetic layer 22′ formed of FeCo or other ferromagnetic material is formed. A first nonmagnetic layer 26 formed of Cr, Ru, Rh, Ir, or the like is formed on the first FeCo ferromagnetic layer 22′. A second FeCo ferromagnetic layer 22′, a second NiFe soft magnetic layer 24, and a second FeCo ferromagnetic layer 22 are formed, in that order, on the first nonmagnetic layer 26. An intermediate nonmagnetic layer 28, formed of a NiCr alloy or the like, is formed on the second FeCo ferromagnetic layer 22. A third FeCo ferromagnetic layer 22, a third NiFe soft magnetic layer 24, and a third FeCo ferromagnetic layer 22′ are thereon formed in that order. A second nonmagnetic layer 26 formed of Cr, Ru, Rh, Ir, or the like is formed on the third FeCo ferromagnetic layer 22′. A fourth FeCo ferromagnetic layer 22′, a fourth NiFe soft magnetic layer 24, and a fourth FeCo ferromagnetic layer 22 are formed in that order on the second nonmagnetic layer 26. A nonmagnetic protective layer 29 formed of a NiCr alloy or the like is formed on the fourth FeCo ferromagnetic layer 22.

The above-described layer structure is characterized in that the NiFe soft magnetic layer 24 is inserted in each of the FeCo ferromagnetic layers 22 disposed above and below the nonmagnetic layer 26. The NiFe soft magnetic layers 24 are disposed in the vicinity sides of the nonmagnetic layer 26 with respect to a center in a layer thickness direction of the FeCo ferromagnetic layer 22. Labeling the FeCo ferromagnetic layer 22′ (the first to the fourth) between the NiFe soft magnetic layer 24 and the nonmagnetic layer 26 a FeCo layer adjacent the nonmagnetic layer. The FeCo ferromagnetic layer 22 and the FeCo layer adjacent the nonmagnetic layer 22′ are ferromagnetically coupled via the NiFe soft magnetic layer 24. Meanwhile, the FeCo layers adjacent the nonmagnetic layer 22′ on top and beneath the nonmagnetic layer 26 are antiferromagnetically coupled via the nonmagnetic layer 26. In FIG. 1, reference numeral 30 denotes a magnetization direction of each magnetic layer.

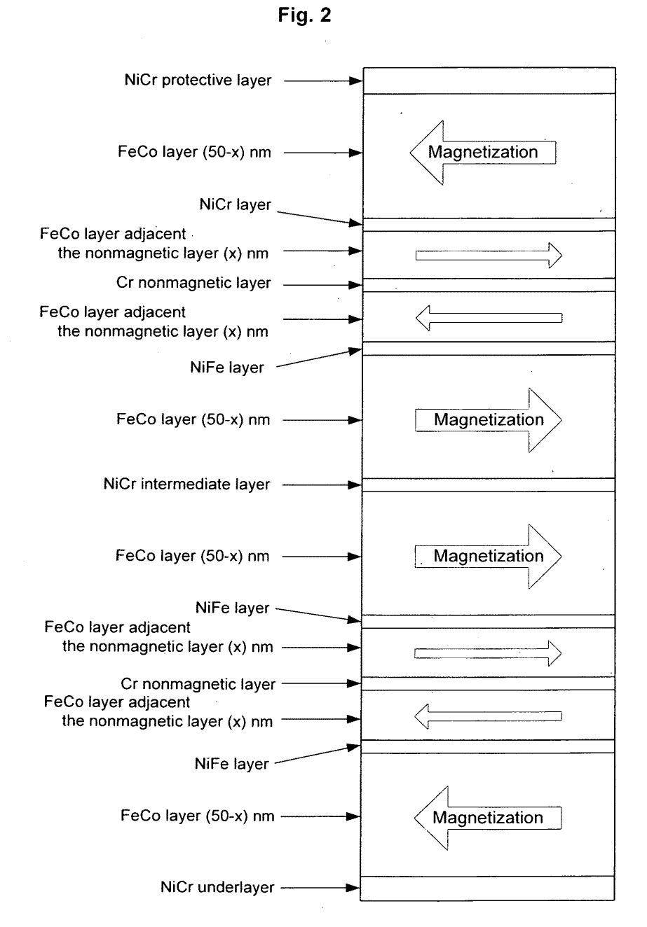

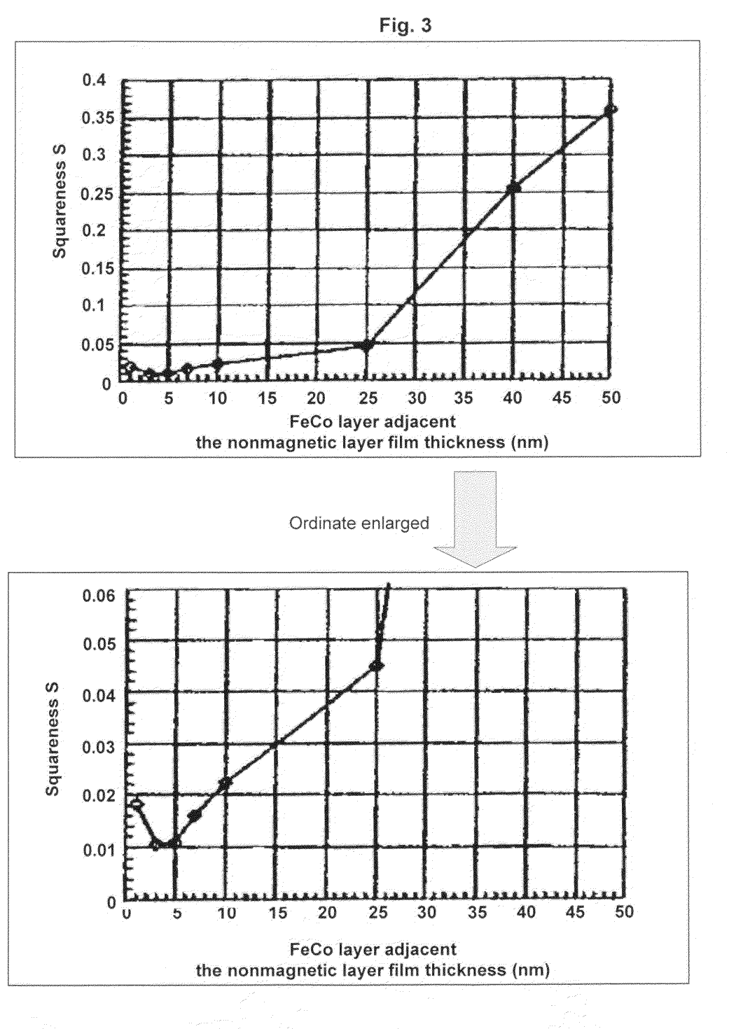

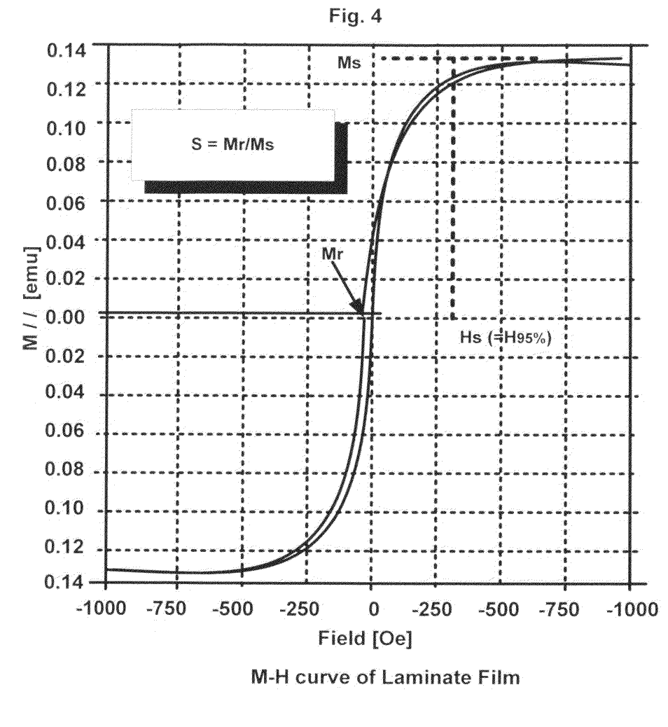

The main magnetic pole piece 2 according to an embodiment of the present invention was manufactured and evaluated in terms of film characteristics. FIG. 2 is a view showing composition and film thicknesses of the main magnetic pole piece 2 manufactured. The FeCo layer was adapted to have a total film thickness of 200 nm. FIG. 3 are diagrams showing values of the squareness S when a film thickness x (nm) of the FeCo layer adjacent the nonmagnetic layer is varied by shifting the position of the NiFe layer. FIG. 3 shows that thinning the FeCo layer adjacent the nonmagnetic layer decreases the squareness S; in particular, when the FeCo layer adjacent the nonmagnetic layer has a film thickness of 1 to 7 nm; specifically, inserting the NiFe soft magnetic layer 24 in a position 1 to 7 nm away from the nonmagnetic layer 26 results in the squareness S being 0.02 or less. That is, an extremely small squareness S could be obtained as compared with S=0.36 in the known art structure. FIG. 4 is a diagram showing a magnetization curve to find the squareness S. In this magnetization curve, magnetization when the magnetization is saturated is a saturation magnetization Ms and that with a magnetic field of 0 is the remanent magnetization Mr. A magnetic field when magnetization reaches 95% of the saturation magnetization Ms is a saturation magnetic field Hs. The squareness S can be obtained using Mr/Ms.

Reasons why there is a substantial decrease in the squareness S by inserting the NiFe soft magnetic layer 24 in the FeCo ferromagnetic layers 22 and making thinner the FeCo layer adjacent the nonmagnetic layer 22′ will be described below. Let J_{AF} be exchange-coupling energy in antiferromagnetic coupling, then J_{AF} may be expressed by the following equation:

J_{AF}=Bs·t·Hs

(Bs: saturation magnetic flux density; t: magnetic layer film thickness; Hs: saturation magnetic field)

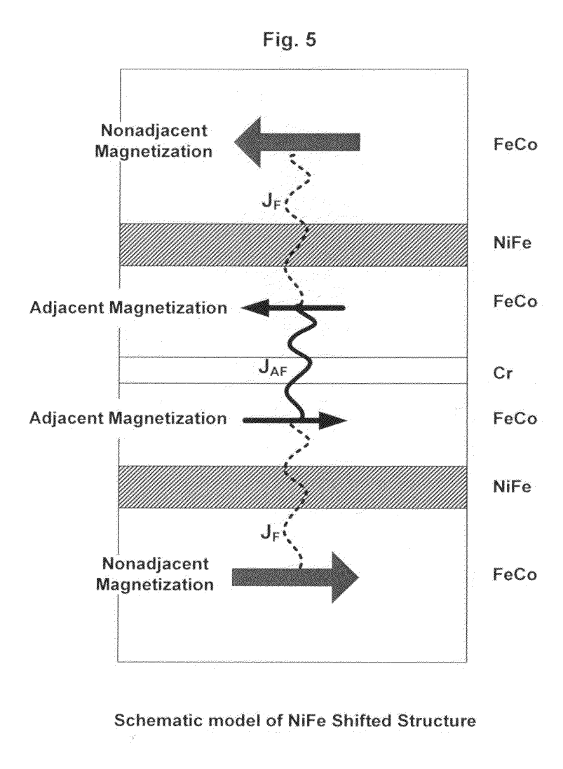

Assuming that J_{AF} and Bs are constant, t is inversely proportional to Hs; specifically, the thinner the magnetic layer film thickness the greater the saturation magnetic field Hs, so that the antiferromagnetic coupling becomes strong to decrease the squareness S. Let us consider a model shown in FIG. 5 to describe the decrease in the squareness S by the thinning of the FeCo layer adjacent the nonmagnetic layer 22′. In the model shown in FIG. 5, magnetization of the FeCo layer adjacent the nonmagnetic layer (FeCo layer adjacent Cr) is defined as “adjacent magnetization” and magnetization of the FeCo ferromagnetic layer not adjacent the nonmagnetic layer (Cr layer) is defined as “nonadjacent magnetization”. The antiferromagnetic coupling J_{AF} acts between the adjacent magnetization layers via the Cr layer. A ferromagnetic coupling J_{F} acts between the adjacent magnetization layer and the nonadjacent magnetization layer via a NiFe intermediate layer. The adjacent magnetization layer and the nonadjacent magnetization layer are separated from each other by the NiFe intermediate layer that has a smaller saturation magnetic flux density than, and a crystal structure different from, those of the FeCo layer. Accordingly, the ferromagnetic coupling J_{F} between the adjacent magnetization and nonadjacent magnetization layers is weak, so that it can be assumed that the adjacent magnetization layer is substantially independent magnetically. Consequently, the antiferromagnetic coupling J_{AF} is determined by the film thickness of the adjacent magnetization layer (FeCo layer adjacent Cr) and the antiferromagnetic coupling between the FeCo layers adjacent Cr becomes more intense with a thinner FeCo layer adjacent Cr. Specifically, the effective film thickness of the magnetic layer decreases with a thinner FeCo layer adjacent Cr, which results in a decreased squareness S.

Reasons for the decreased squareness S will be described below. As the FeCo layer becomes thicker, crystal grains grow to increase roughness at an interface. If the FeCo layer adjacent Cr is thick, crystal grains of the FeCo layer adjacent Cr are large with the resultant greater roughness at the interface. In this case, a magnetic charge generated at the interface becomes great, so that magnetostatic coupling ferromagnetically coupling the FeCo layer adjacent Cr becomes great. This is considered to be the reason for an increased squareness S. If the NiFe intermediate layer is inserted in the FeCo layer, it is considered that the FeCo crystal grain growth is reset and started from a flat NiFe intermediate layer surface. If the FeCo layer adjacent Cr is thin, therefore, the FeCo crystal grains do not grow much. The crystal grains are small with the resultant small interface roughness. In this case, the magnetic charge generated at the interface becomes small, so that the magnetostatic coupling ferromagnetically coupling the FeCo layer adjacent Cr becomes small. This is considered to be the reason for the decreased squareness S.

As described heretofore, embodiments of the present invention can provide a main magnetic pole structure that ensures a markedly smaller squareness S (smaller remanent magnetization Mr) than the known art structure without inviting a reduced current response characteristic of the head or a degraded overwrite characteristic, though there is only a slight increase in the saturation magnetic field Hs. Embodiments of the invention can therefore provide a perpendicular magnetic recording head suppressing erasure after recording and suitable for high recording densities.

The embodiments of the present invention described heretofore provide the main magnetic pole piece 2 that has a structure including the multilayered films stacked one on top of another via the NiCr intermediate nonmagnetic layer 28, each multilayered film having the nonmagnetic layer 26 including one or a plurality of elements selected from the group consisting of Cr, Ru, Rh, and Ir, the FeCo ferromagnetic layers 22 disposed above and below the nonmagnetic layer 26, and the NiFe soft magnetic layers 24 inserted in the FeCo ferromagnetic layers 22 on the sides of the nonmagnetic layer 26 with respect to the center in the layer thickness direction of each FeCo ferromagnetic layer 22. The multilayered film may, instead, be single, even in which case, the same effect can be achieved as that of the above-described embodiment of the present invention. Specifically, the above effect can be achieved by the NiFe soft magnetic layers 24 being inserted in the FeCo ferromagnetic layers 22 on the sides of the nonmagnetic layer 26 with respect to the center in the layer thickness direction of each FeCo ferromagnetic layer 22.

What is claimed is:

1. A perpendicular magnetic recording bead comprising:
a main magnetic pole piece;
an auxiliary magnetic pole piece magnetically coupled to the main magnetic pole piece on a side opposite an air bearing surface; and
a coil generating a magnetic flux in the main magnetic pole piece and the auxiliary magnetic pole piece;
wherein the main magnetic pole piece includes a multilayered film having:
a nonmagnetic layer including one or a plurality of elements selected from the group consisting of Cr, Ru, Rh, and Ir;
FeCo ferromagnetic layers disposed above and below the nonmagnetic layer; and
NiFe soft magnetic layers inserted in the FeCo ferromagnetic layers in the vicinity sides of the nonmagnetic layer with respect to a center in a layer thickness direction of each FeCo ferromagnetic layer.

2. The perpendicular magnetic recording head according to claim 1
wherein the FeCo ferromagnetic layers disposed above and below the NiFe soft magnetic layers are ferromagnetically coupled and the FeCo ferromagnetic layers disposed above and below the nonmagnetic layer are antiferromagnetically coupled.

3. The perpendicular magnetic recording head according to claim 1,
wherein, if the FeCo ferromagnetic layer disposed between the NiFe soft magnetic layer and the nonmagnetic layer is a FeCo layer adjacent the nonmagnetic layer in the multilayered film, the FeCo layer adjacent the nonmagnetic layer has a film thickness of 1 nm or more and 7 nm or less

4. The perpendicular magnetic recording head according to claim 2,
wherein, if the FeCo ferromagnetic layer disposed between the NiFe soft magnetic layer and the nonmagnetic layer is a FeCo layer adjacent the nonmagnetic layer in the multilayered film, the FeCo layer adjacent the nonmagnetic layer has a film thickness of 1 nm or more and 7 nm or less

5. The perpendicular magnetic recording head according to claim 1,
wherein, in the multilayered film, the FeCo ferromagnetic layers above and below the nonmagnetic layer have a film thickness of about 50 nm or more; and
wherein, if the FeCo ferromagnetic layer disposed between the NiFe soft magnetic layer and the nonmagnetic layer is a FeCo layer adjacent the nonmagnetic layer, the FeCo layer adjacent the nonmagnetic layer has a film thickness of 1 nm or more and 7 nm or less.

6. The perpendicular magnetic recording head according to claim 2,
wherein, in the multilayered film, the FeCo ferromagnetic layers above and below the nonmagnetic layer have a film thickness of about 50 nm or more; and
wherein, if the FeCo ferromagnetic layer disposed between the NiFe soft magnetic layer and the nonmagnetic layer is a FeCo layer adjacent the nonmagnetic layer, the FeCo layer adjacent the nonmagnetic layer has a film thickness of 1 nm or more and 7 nm or less.

7. The perpendicular magnetic recording head according to claim 1,
wherein a distance between the nonmagnetic layer and the NiFe soft magnetic layer is 1 nm or more and 7 nm or less.

8. The perpendicular magnetic recording head according to claim 2,
wherein a distance between the nonmagnetic layer and the NiFe soft magnetic layer is 1 nm or more and 7 nm or less.

9. The perpendicular magnetic recording head according to claim 1,
wherein a plurality of multilayered films is stacked one on top of another via a NiCr intermediate nonmagnetic layer.

10. A perpendicular magnetic recording head comprising:
a write head including a main magnetic pole piece, an auxiliary magnetic pole piece magnetically coupled to the main magnetic pole piece on a side opposite an air bearing surface, and a coil generating a magnetic flux in the main magnetic pole piece and the auxiliary magnetic pole piece; and
a read head including a magnetoresistive sensor disposed between an upper magnetic shield and a lower magnetic shield;
wherein the main magnetic pole piece includes a multilayered film having a nonmagnetic layer including one or a plurality of elements selected from the group consisting of Cr, Ru, Rh, and Ir, FeCo ferromagnetic layers disposed above and below the nonmagnetic layer, and NiFe soft magnetic layers inserted in the FeCo ferromagnetic layers in the vicinity sides of the nonmagnetic layer with respect to a center in a layer thickness direction of each FeCo ferromagnetic layer.

11. The perpendicular magnetic recording head according to claim 10,
wherein the FeCo ferromagnetic layers disposed above and below the NiFe soft magnetic layers are ferromagnetically coupled and the FeCo ferromagnetic layers disposed above and below the nonmagnetic layer are antiferromagnetically coupled.

12. The perpendicular magnetic recording head according to claim 10,
wherein, if the FeCo ferromagnetic layer disposed between the NiFe soft magnetic layer and the nonmagnetic layer is a FeCo layer adjacent the nonmagnetic layer in the multilayered film, the FeCo layer adjacent the nonmagnetic layer has a film thickness of 1 nm or more and 7 nm or less.

13. The perpendicular magnetic recording head according to claim 11,
wherein, if the FeCo ferromagnetic layer disposed between the NiFe soft magnetic layer and the nonmagnetic layer is a FeCo layer adjacent the nonmagnetic layer in the multilayered film, the FeCo layer adjacent the nonmagnetic layer has a film thickness of 1 nm or more and 7 nm or less.

14. The perpendicular magnetic recording head according to claim 10,
wherein a distance between the nonmagnetic layer and the NiFe soft magnetic layer is 1 nm or more and 7 nm or less.

15. The perpendicular magnetic recording head according to claim 11,
wherein a distance between the nonmagnetic layer and the NiFe soft magnetic layer is 1 nm or more and 7 nm or less.

16. The perpendicular magnetic recording head according to claim 10,
wherein a plurality of multilayered films is stacked one on top of another via a NiCr intermediate nonmagnetic layer.
